(19) United States
(12) Patent Application Publication
(10) Pub. No.: US 2026/0249144 A1
(43) Pub. Date: Aug. 27, 2026

(54) GOLF CLUB SHAFT, GOLF CLUB, AND METHOD FOR MANUFACTURING GOLF CLUB SHAFT

(71) Applicant: FUJIKURA COMPOSITES INC., Tokyo (JP)

(72) Inventors: Yoshihito KOGAWA, Saitama (JP); Keigo TAKAHASHI, Saitama (JP)

(21) Appl. No.: 19/649,635

(22) Filed: Apr. 16, 2026

Related U.S. Application Data
(62) Division of application No. 18/676,936, filed on May 29, 2024.
Application No. 18/676,936 is a continuation of application No. PCT/JP2022/034302, filed on Sep. 14, 2022.

(30) Foreign Application Priority Data
Dec. 1, 2021 (JP) 2021-195148

(51) Int. Cl. A63B 53/10; B29C 53/00; B29C 53/56; B29C 70/30; A63B 60/54; B29K 9/00; B29K 19/00; B29K 23/00; B29K 83/00; B29K 105/08; B29K 307/04; B29L 31/52

(52) U.S. Cl. CPC A63B 53/10; B29C 53/005; B29C 53/562; B29C 70/30; A63B 60/54; A63B 2209/02; B29K 2009/00; B29K 2019/00; B29K 2023/22; B29K 2083/00; B29K 2105/08; B29K 2307/04; B29K 2995/0089; B29L 2031/5227

(57) ABSTRACT

Provided is a golf club shaft having a lightweight property and exhibiting impact-absorption characteristics to suppress vibration at an impact of a golf ball. A golf club shaft, including a shaft body extending in a longitudinal direction, wherein the shaft body is composed of a composite material which has: a first member containing a fiber reinforced plastic; and a second member containing a rubber material and formed to be in direct contact with the first member within at least a part of a region on the first member, and in which the first member and the second member are integrated.

### CROSS REFERENCE TO RELATED APPLICATIONS

The present application is a Divisonal of U.S. serial no. 18/676,936 filed on May 29, 2024, which is a continuation application of International Patent Application No. PCT/JP2022/034302 filed on September 14, 2022, which claims the benefit of Japanese Patent Application No. 2021-195148, filed on December 1, 2021. The contents of these applications are incorporated herein by reference in their entirety.

### BACKGROUND

### Technical Field

The present disclosure relates to a golf club shaft composed of a composite material containing a fiber reinforced plastic and a rubber material, a golf club using the golf club shaft, and a method for manufacturing the golf club shaft.

### BACKGROUND

As a material for a golf club shaft, steel, fiber reinforced plastic (FRP), and the like have been used in terms of a lightweight property and strength. As the golf club shaft made of steel, a golf club shaft comprising a shaft body, a film formed by chemically treating outer and inner surfaces of the shaft body, a coating layer formed by electrodeposition coating on at least an outer film, and a pigment layer applied on the coating layer, the pigment layer having a polarizing powder dispersed therein, has been proposed (Japanese Patent Laid-Open No. 2010-246824).

In Japanese Patent Laid-Open No. 2010-246824, the pigment layer in which the polarizing powder is dispersed is formed on the coating layer formed by electrodeposition coating on the chemically treated film, and thereby the golf club shaft has excellent appearance compared with a conventional golf club shaft by plating and has an antirust effect inside the shaft, and avoids increase in weight of the golf club shaft due to plating to attempt to reduce the weight.

Meanwhile, since fiber reinforced plastic (FRP) has both a lightweight property and high strength, it has been widely used in recent years as the material for the golf club shaft instead of steel. As a golf club shaft using the fiber reinforced plastic, for example, a golf club shaft comprising a carbon-fiber reinforced plastic composed of a laminate of a plurality of resin-impregnated carbon fiber layers, wherein resin layers formed from an epoxy resin composition are disposed between the resin-impregnated carbon fiber layers has been proposed (Japanese Patent Laid-Open No. 2016-87460).

In Japanese Patent Laid-Open No. 2016-87460, the strength of the golf club shaft composed of the fiber reinforced plastic is improved by disposing the epoxy resin layers between the resin-impregnated fiber layers to inhibit interlayer peeling of the resin-impregnated fiber layers without decrease in elastic modulus of the golf club shaft composed of the fiber reinforced plastic.

Meanwhile, the golf club is required to have not only the lightweight property and the high strength but also a clear hit feeling (hit comfort). For the golf club having the clear hit feeling, the golf club shaft is required to exhibit impact-absorption characteristics to suppress vibration of the golf club shaft at an impact of a golf ball. With the golf club shaft of Japanese Patent Laid-Open No. 2010-246824 composed of steel and the golf club shaft of Japanese Patent Laid-Open No. 2016-87460 composed of the epoxy resin layers disposed between the fiber reinforced plastic layers and the fiber reinforced plastic layers, there is room for improvement in terms of the golf club exhibiting the clear hit feeling by suppressing vibration of the golf club shaft at an impact of a golf ball.

### SUMMARY

The present disclosure is related to providing a golf club shaft having a lightweight property and exhibiting impact-absorption characteristics to suppress vibration at impact of a golf ball, a golf club having the golf club shaft, and a method for manufacturing the golf club shaft.

A summary of configurations of the present disclosure is as follows.

[1] A golf club shaft, comprising a shaft body extending in a longitudinal direction, wherein

the shaft body is composed of a composite material which has: a first member containing a fiber reinforced plastic; and a second member containing a rubber material and formed to be in direct contact with the first member within at least a part of a region on the first member, and in which the first member and the second member are integrated.

[2] The golf club shaft according to [1], wherein a part of the first member and the second member are in direct contact, and an adhesive member is not interposed between the first member and the second member.

[3] The golf club shaft according to [1] or [2], wherein the first member and the second member are sheet-like, and the composite material has a laminate structure.

[4] The golf club shaft according to [1] or [2], wherein the rubber material is at least one selected from the group consisting of nitrile rubber, fluorine rubber, butyl rubber, ethylene-propylene-diene rubber, hydrogenated nitrile rubber, and silicone rubber.

[5] The golf club shaft according to [1] or [2], wherein the rubber material is at least one selected from the group consisting of nitrile rubber, fluorine rubber, and butyl rubber.

[6] The golf club shaft according to [1] or [2], wherein the fiber reinforced plastic is a carbon-fiber reinforced plastic.

[7] The golf club shaft according to [1] or [2], wherein the first member is a multilayer structure having: a first one of the fiber reinforced plastic that forms a first layer in which a fiber orientation angle is a first direction; and a second one of the fiber reinforced plastic that forms a second layer in which a fiber orientation angle is a second direction different from the first direction.

[8] The golf club shaft according to [1] or [2], wherein an outer surface of the composite material is of the first member.

[9] The golf club shaft according to [1] or [2], wherein the shaft body has: a first region where a shaft outer diameter relatively gradually decreases; a second region where the shaft outer diameter relatively steeply decreases; and a third region where a relative amount of change in the shaft outer diameter is smallest, in this order from a base end side toward a distal end side in the longitudinal direction.

[10] A golf club, wherein a club head and a grip are attached to the golf club shaft according to [1] or [2].

[11] A method for manufacturing a golf club shaft, the method comprising:

a step of providing a first precursor being an uncured or semi-cured material in which a fiber is impregnated with a resin;

a step of directly laminating a second precursor containing an unvulcanized rubber onto at least a part of a region on the provided first precursor to obtain a laminate of the first precursor and the second precursor;

a step of winding the obtained laminate on an outer peripheral surface of a mandrel;

a step of heat-treating the laminate wound on the outer peripheral surface of the mandrel to obtain a first member containing a fiber reinforced plastic by thermally curing the resin of the first precursor and obtain a second member containing a rubber material by vulcanizing the unvulcanized rubber of the second precursor, and integrating the first member and the second member to obtain a wound composite material; and

a step of withdrawing the mandrel from the wound composite material.

[12] The method for manufacturing a golf club shaft according to, wherein the second precursor containing an unvulcanized rubber blended with a vulcanizer is directly laminated onto the provided first precursor without interposing an adhesive member.

According to an aspect of the golf club shaft of the present disclosure, a second member containing a rubber material has a vibration-attenuating property by the golf club shaft comprising a shaft body extending in a longitudinal direction of a golf club, wherein the shaft body is composed of a composite material which has: a first member containing a plurality of laminated layers of a fiber reinforced plastic; and a second member containing the rubber material and formed to be in direct contact with the first member within at least a part of a region on the first member, and in which the first member and the second member are integrated, and thereby the shaft body exhibits impact-absorption characteristics to suppress vibration of the golf club shaft at an impact of a golf ball. Therefore, according to an aspect of the golf club shaft of the present disclosure, clear hit feeling can be imparted to the golf club. In addition, according to an aspect of the golf club shaft of the present disclosure, the composite material constituting the golf club shaft has a lightweight property and strength by containing the first member containing a plurality of laminated layers of the fiber reinforced plastic. Further, according to an aspect of the golf club shaft of the present disclosure, peeling between the first member and the second member is prevented by the first member containing a plurality of laminated layers of the fiber reinforced plastic and the second member containing the rubber material that are integrated in the composite material constituting the golf club shaft.

According to an aspect of the golf club shaft of the present disclosure, a part of the plurality of laminated layers of the first member and the second member are in direct contact, and an adhesive member is not interposed between the first member and the second member, and adhesion unevenness due to the adhesive member is prevented, resulting in certainly preventing the peeling between the first member and the second member.

According to an aspect of the golf club shaft of the present disclosure, the rubber material is at least one selected from the group consisting of nitrile rubber, fluorine rubber, butyl rubber, ethylene-propylene-diene rubber, hydrogenated nitrile rubber, and silicone rubber, and thereby tightness between the first member and the second member is obtained, and the peeling can be further prevented.

According to an aspect of the golf club shaft of the present disclosure, the rubber material is at least one selected from the group consisting of nitrile rubber, fluorine rubber, and butyl rubber, and thereby tightness between the first member and the second member is certainly obtained, and the peeling can be further certainly prevented.

In an aspect of the method for manufacturing a golf club shaft of the present disclosure, a second precursor containing an unvulcanized rubber is directly laminated to at least a part of a region on the first precursor being an uncured or semi-cured material of a fiber impregnated with a resin to obtain a laminate, and the laminated is heat-treated to obtain a first member containing a fiber reinforced plastic by thermally curing the resin of the first precursor and obtain a second member containing a rubber material by vulcanizing the unvulcanized rubber of the second precursor, and the first member and the second member are integrated. That is, the laminate is heat-treated for the prepreg being the uncured or semi-cured material in which the fiber is impregnated with the resin to be subjected to the thermally curing treatment, and for the unvulcanized rubber to be vulcanized to simultaneously obtain the fiber reinforced plastic and the vulcanized rubber material, and to integrate the obtained fiber reinforced plastic and the vulcanized rubber material.

Therefore, according to an aspect of the method for manufacturing a golf club shaft of the present disclosure, a step itself of applying an adhesive is not required, and uniformly applying an adhesive is also not required for adhering the first member containing the fiber reinforced plastic and the second member containing the rubber material. Accordingly, in the manufacturing method of the present disclosure, complication of manufacturing steps of the composite material of the fiber reinforced plastic and the rubber material can be prevented, and manufacturing of the golf club shaft can be simplified. In addition, according to an aspect of the method for manufacturing a golf club shaft of the present disclosure, the laminated is heat-treated for thermally curing the resin of the first precursor to obtain the first member containing the fiber reinforced plastic, and for vulcanizing the unvulcanized rubber of the second precursor to obtain the second member containing the rubber material, and the first member and the second member are integrated, and therefore the composite material of the fiber reinforced plastic and the rubber material, which can prevent the peeling between the first member and the second member, can be prepared. As a result, the golf club shaft having a lightweight property and high strength, and exhibiting impact-absorption characteristics to suppress vibration at an impact of a golf ball can be manufactured.

According to an aspect of the method for manufacturing a golf club shaft of the present disclosure, the second precursor containing the unvulcanized rubber is directly laminated onto the first precursor without interposing an adhesive member to prevent adhesion unevenness due to the adhesive member, resulting in certainly preventing the peeling between the first member and the second member.

### BRIEF DESCRIPTION OF THE DRAWINGS

FIG. 1 is an explanatory view illustrating an outline of a side of a golf club having a golf club shaft according to an example of an embodiment of the present disclosure;

FIG. 2 is an explanatory view illustrating an outline of a part of an embodiment of a composite material constituting a shaft body of a golf club shaft according to an example of an embodiment of the present disclosure;

FIG. 3 is an explanatory view illustrating a front outline of a distal end of a golf club shaft according to an example of an embodiment of the present disclosure; and

FIG. 4 is a graph indicating results of a vibration test of a golf club shaft of Embodiment and a golf club shaft of Comparative Embodiment.

### DETAILED DESCRIPTION

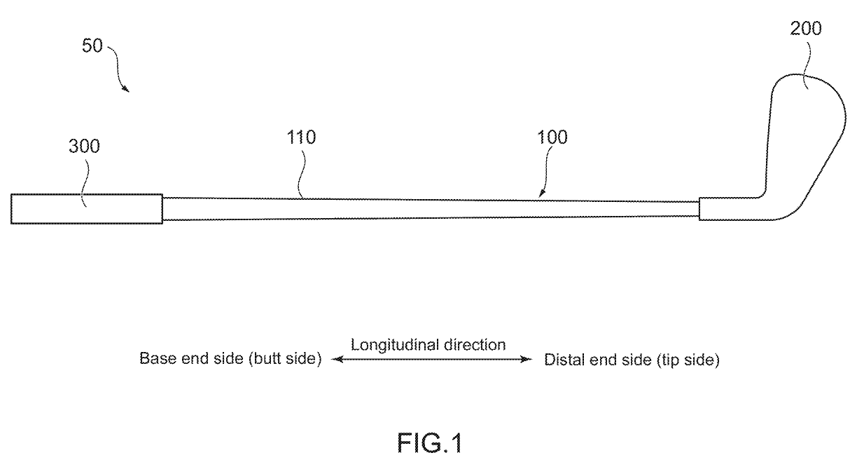

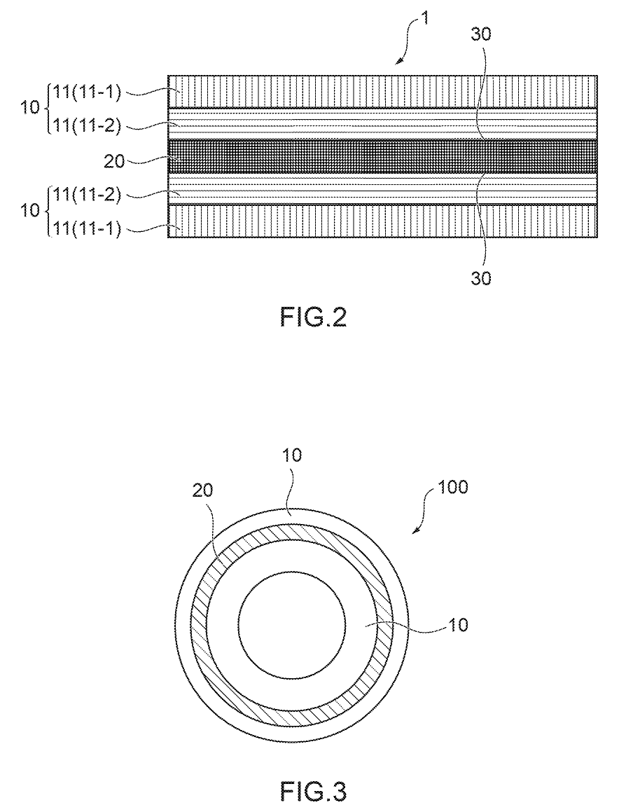

Hereinafter, details of a golf club shaft of the present disclosure will be described. FIG. 1 is an explanatory view illustrating an outline of a side of a golf club having the golf club shaft according to an example of an embodiment of the present disclosure. FIG. 2 is an explanatory view illustrating an outline of an embodiment of a composite material constituting a shaft body of the golf club shaft according to an example of an embodiment of the present disclosure. FIG. 3 is an explanatory view illustrating a front outline of a distal end of the golf club shaft according to an example of an embodiment of the present disclosure.

As illustrated in FIG. 1, a golf club 50 has a golf club shaft 100 extending in a longitudinal direction, a club head 200 attached onto a distal end side (tip side) of the golf club shaft 100, and a grip 300 attached onto a base end side (butt side) of the golf club shaft 100.

The golf club shaft 100 has a shaft body 110 extending in the longitudinal direction. The shaft body 110 is a hollow cylindrical member. The golf club shaft 100 has a structure in which an outer diameter of the shaft body 110 decreases at a predetermined taper rate from the base end side (butt side) toward the distal end side (tip side).

As illustrated in FIG. 2, the shaft body 110 is composed of a composite material 1 of the fiber reinforced plastic and the rubber material, which has a first member 10 containing a fiber reinforced plastic, and a second member 20 containing a rubber material and formed to be in direct contact with the first member 10 within at least a part of a region on the first member 10, and in which the first member 10 and the second member 20 are integrated. The composite material 1 constituting the shaft body 110 forms a bonding part 30 in which the first member 10 is bonded to the second member 20 by integrating the first member 10 with the second member 20, and the first member 10 and the second member 20 are integrated. The composite material 1 is integrated in a state where at least a part of a region on the first member 10 is in direct contact with the second member 20. In the composite material 1 constituting the shaft body 110, the first members 10 containing the fiber reinforced plastic are disposed on both sides of the second member 20 containing the rubber material. Therefore, the second member 20 containing the rubber material is interposed between the first members 10 containing the fiber reinforced plastic.

As illustrated in FIG. 2, in the composite material 1 constituting the shaft body 110, an adhesive member such as an adhesive is not interposed between the first member 10 and the second member 20 in the bonding part 30 where the first member 10 and the second member 20 are in direct contact. In the composite material 1, at least a part of a region on the first member 10 is integrated with the second member 20 in a state of directly contacting with the second member 20, and at least a part of a region on the second member 20 is integrated with the first member 10 in a state of directly contacting with the first member 10.

In the composite material 1, a substantially entire surface of the first member 10 opposite to the second member 20 adheres to the second member 20 in a state of directly contacting with the second member 20. In addition, a substantially entire surface of the second member 20 opposite to the first member 10 adheres to the first member 10 in a state of directly contacting with the first member 10. Therefore, in the composite material 1, an adhesive member is not interposed over an entirety of the bonding part 30 where the first member 10 and the second member 20 are opposite to each other.

In the composite material 1 being the material constituting the shaft body 110, a surface portion of the fiber reinforced plastic constituting the first member 10 and a part of a matrix in a proximity of the surface portion enter a surface portion of the rubber material constituting the second member 20 and a proximity of the surface portion, and the surface portion of the rubber material constituting the second member 20 and a part of the proximity of the surface portion enter the surface portion of the fiber reinforced plastic constituting the first member 10 and the proximity of the surface portion. Thus, the first member 10 is bonded to the second member 20 to form the bonding part 30, and the first member 10 and the second member 20 are integrated. That is, in the bonding part 30 in the composite material 1, the first member 10 exhibits an anchor effect relative to the second member 20, the second member 20 exhibits an anchor effect relative to the first member 10, and therefore the first member 10 and the second member 20 are integrated.

A shape of the composite material 1 constituting the shaft body 110 is sheet-like for both the first member 10 and the second member 20. Therefore, the composite material 1 has a sheet-like laminate structure.

The composite material 1 is a composite material of the fiber reinforced plastic and the rubber material, which has the first member 10 containing the fiber reinforced plastic and the second member 20 containing the rubber material and in direct contact with the first member 10 in at least a part of a region on the surface of the first member 10, and in which the first member 10 and the second member 20 are integrated by the above anchor effect to prevent peeling between the first member 10 containing the fiber reinforced plastic and the second member 20 containing the rubber member. Since the shaft body 110 is composed of the composite material 1 to allow the second member 20 containing the rubber material in the composite material 1 to have a vibration-attenuating property, the shaft body 110 exhibits impact-absorption characteristics at an impact of a golf ball to suppress vibration of the golf club shaft 100. Therefore, according to an aspect of the golf club shaft 100 of the present disclosure, the clear hit feeling can be imparted to the golf club 50. In addition, according to an aspect of the golf club shaft 100 of the present disclosure, the peeling between the first member 10 and the second member 20 is prevented by strongly integrating the first member 10 containing the fiber reinforced plastic and the second member 20 containing the rubber material in the composite material 1 constituting the shaft body 110.

In addition, in the composite material 1, the first member 10 and the second member 20 are in direct contact over an entirety of the bonding part 30, and an adhesive member is not interposed between the first member 10 and the second member 20. Thus, adhesion unevenness due to the adhesive member is prevented, and thereby the peeling between the first member 10 and the second member 20 is certainly prevented.

Examples of the fiber reinforced plastic constituting the first member 10 include carbon-fiber reinforced plastic (CFRP), glass-fiber reinforced plastic (GFRP), aramid-fiber reinforced plastic (AFRP), and cellulose-fiber reinforced plastic. Among these, the carbon-fiber reinforced plastic is preferable in terms of the lightweight property and high strength suitable for the golf club shaft 100. As for a matrix resin of the fiber reinforced plastic, the resin component is not particularly limited. Specific examples of the resin component include thermosetting resins such as an epoxy resin, a phenol resin, a cyanate resin, a vinyl ester resin, and an unsaturated polyester resin. The fiber reinforced plastic constituting the first member 10 is a thermally cured member of an uncured (or semi-cured) thermally curable prepreg, which is an intermediate material of fiber impregnated with the matrix resin, by a heating treatment and the like.

As illustrated in FIG. 2, in the composite material 1, the first member 10 is a multilayer structure having: a first fiber reinforced plastic layer 11 (11-1) in which a fiber orientation angle is a first direction; and a second fiber reinforced plastic layer 11 (11-2) in which a fiber orientation angle is a second direction different from the first direction. The first member 10 is a structure of the fiber reinforced plastic with a plurality of the layers such that the fiber orientation angles are different, and thereby strength in the entire surface direction of the first member 10 is improved. Although the first member 10 in FIG. 2 is a multilayer structure composed of two fiber reinforced plastic layers 11 for convenience of description, the first member 10 may be a multilayer structure having three or more fiber reinforced plastic layers 11 in terms of a balance between the lightweight property and the strength suitable for the golf club shaft 100. In a case of the multilayer structure having three or more fiber reinforced plastic layers 11, fiber reinforced plastic layers 11 having different fiber orientation angles from each other, such as a third fiber reinforced plastic layer 11 in which a fiber orientation angle is a third direction different from the first direction and the second direction, and a fourth fiber reinforced plastic layer 11 in which a fiber orientation angle is a fourth direction different from the first direction, the second direction, and the third direction, may be further provided in addition to the first fiber reinforced plastic layer 11 and the second fiber reinforced plastic layer 11. In addition, the first member 10 may be a structure composed of one fiber reinforced plastic layer 11 in terms of the lightweight property suitable for the golf club shaft 100 as necessary.

Examples of the rubber material constituting the second member 20 to mainly impart the impact-absorption characteristics to the shaft body 110 include nitrile rubber (NBR) such as acrylonitrile-butadiene rubber, fluorine rubber (FKM), butyl rubber (IIR), ethylene-propylene-diene rubber (EPDM), hydrogenated nitrile rubber (HNBR), silicone rubber, urethane rubber, acryl rubber (ACM), isoprene rubber (IR), styrene rubber (SBR), butadiene rubber (BR), ethylene-propylene rubber (EPM), chloroprene rubber (CR), chlorinated polyethylene rubber, and natural rubber (NR). These rubber materials may be used singly, or may be used in combination of two or more. The rubber material constituting the second member 20 is a vulcanized member of an unvulcanized rubber by a heating treatment and the like.

Among these rubber materials, nitrile rubber, fluorine rubber, butyl rubber, ethylene-propylene-diene rubber, hydrogenated nitrile rubber, and silicone rubber are preferable in terms of obtaining tightness between the first member 10 and the second member 20 and imparting further excellent strength to the shaft body 110, and nitrile rubber, fluorine rubber, and butyl rubber are particularly preferable in terms of certainly obtaining the tightness between the first member 10 and the second member 20 and certainly imparting the further excellent strength to the shaft body 110.

Into the second member 20, a vulcanizer is blended in addition to the rubber material. According to use conditions and the like of the shaft body 110, additives such as an antiaging agent, a processing auxiliary, a thickener, a vulcanization-accelerating auxiliary, a filler, a plasticizer, and a vulcanization accelerator may be blended as necessary in addition to the rubber material blended with the vulcanizer.

A specific laminated structure of the first member 10 and the second member 20 in the composite material 1 constituting the shaft body 110 will be described. The composite material 1 constituting the shaft body 110 has a laminated structure in which the first member 10 is disposed on at least an outer surface among the outer surface and an inner surface forming a main surface of the composite material 1. That is, the outer surface of the shaft body 110 is of the first member 10 containing the fiber reinforced plastic in the composite material 1. The layer of the second member 20 containing the rubber material has a state of, for example, being interposed between the first members 10 containing the fiber reinforced plastic. As for the layer of the second member 20 containing the rubber material, one layer may be provided, a plurality of the layers may be provided, or the layer of the first member 10 composed of the single or a plurality of the fiber reinforced plastic layer(s) 11 may be further interposed between the layer of the second member 20 and the layer of the second member 20. According to the use conditions, required performance, and the like of the shaft body 110, the number of layers of the first member 10 in the composite material 1, the number of layers of the fiber reinforced plastic layers 11, and the number of layers of the second member 20 can be appropriately selected. Note that the second member 20 is preferably disposed not on the outermost layer or the innermost layer of the shaft body 110 but between the layers of the first member 10.

In the shaft body 110 composed of the composite material 1 in which the outer surface of the composite material 1 is of the first member 10, and the layer of the second member 20 containing the rubber material is interposed between the layers of the first member 10, a deformation amount until breakage due to deflection, bending, and the like becomes large, and deformation resistance of the shaft body 110 is improved. In the shaft body 110 composed of the composite material 1 in which the outer surface of the composite material 1 is of the first member 10, and the layer of the second member 20 is interposed between the layers of the first member 10, the vibration-attenuating property is improved.

The shaft body 110 has a first region, a second region, and a third region in this order from a base end side toward a distal end side in the longitudinal direction of the shaft body 110. In the first region, a shaft outer diameter of the shaft body 110 relatively gradually decreases from the base end side toward the distal end side in the longitudinal direction. In the second region, the shaft outer diameter of the shaft body 110 relatively steeply decreases from the base end side toward the distal end side in the longitudinal direction. In the third region, a relative amount of change in the longitudinal direction in the shaft outer diameter of the shaft body 110 is smallest. The third region is substantially straight, for example. Onto an outer peripheral surface of the first region of the shaft body 110, the grip 300 is attached.

Next, a method for manufacturing a golf club shaft of the present disclosure will be described. For the golf club shaft of the present disclosure, the composite material 1 of the fiber reinforced plastic and the rubber material, which has the first member 10 containing the fiber reinforced plastic and the second member 20 containing the rubber material and formed to be in direct contact with the first member 10, and in which the first member 10 and the second member 20 are integrated, which are described above, is used as a material.

The method for manufacturing a golf club shaft comprises: (1) a step of providing a first precursor being an uncured or semi-cured material in which a fiber is impregnated with a resin; (2) a step of directly laminating a second precursor containing an unvulcanized rubber onto at least a part of a region on the provided first precursor to obtain a laminate of the first precursor and the second precursor; (3) a step of winding the obtained laminate on an outer peripheral surface of a mandrel; (4) a step of heat-treating the laminate wound on the outer peripheral surface of the mandrel, including the mandrel, to obtain a first member 10 containing a fiber reinforced plastic by thermally curing the resin of the first precursor and obtain a second member 20 containing a rubber material by vulcanizing the unvulcanized rubber of the second precursor, and integrating the first member 10 and the second member 20 to obtain a wound composite material 1; and (5) a step of withdrawing the mandrel from the wound composite material 1. The aforementioned method for manufacturing a golf club shaft of the present disclosure is a method called a sheet-winding shaping method.

(1) Step of providing first precursor being uncured or semi-cured material in which fiber is impregnated with resin

This step is providing a prepreg (namely a first precursor) being an uncured or semi-cured material in which a reinforced fiber such as carbon fiber is impregnated with a resin such as a thermosetting resin. As the first precursor, a single-layer prepreg may be used, or a laminated prepreg in which a plurality of layers of the prepreg is laminated may be used. The number of laminated layers of the prepreg may be appropriately selected according to the use conditions, the required performance, and the like of the golf club shaft.

(2) Step of directly laminating second precursor containing unvulcanized rubber onto first precursor to obtain laminate

This step is laminating a second precursor containing an unvulcanized rubber onto a (laminated) prepreg surface being the first precursor to obtain a laminate. In this step, the second precursor containing the unvulcanized rubber is directly laminated onto the first precursor without interposing an adhesive member. For laminating the second precursor onto the first precursor, pressing the laminate of the first precursor and the second precursor, and the like may be performed, for example, as necessary. The laminate obtained in this step is a precursor of the composite material.

(3) Step of winding obtained laminate on outer peripheral surface of mandrel

Provided is a mandrel having a relatively gradual taper surface for forming the first region, a relatively steep taper surface for forming the second region, and a portion with the smallest relative amount of change for forming the third region, as the outer diameter shape. Then, the laminate in which the second precursor is laminated onto the first precursor is wound on the outer peripheral surface of the mandrel.

(4) Step of obtaining wound composite material 1

In the step of obtaining the wound composite material 1, a thermally contracting tape or the like is spirally wound in the longitudinal direction in a state where the laminate of the laminated first precursor and second precursor is wound on the outer peripheral surface of the mandrel to heat-treat the laminate. The laminate is heat-treated for thermally curing the resin of the first precursor to form the fiber reinforced plastic from the prepreg and obtain the first member 10 containing the fiber reinforced plastic and for vulcanizing the unvulcanized rubber of the second precursor to obtain the second member 20 containing the rubber material, and the first member 10 and the second member 20 are integrated to obtain the wound composite material 1. That is, in the step of obtaining the wound composite material 1, the laminate of the first precursor and the second precursor is heat-treated for thermally treating the prepreg being the uncured or semi-cured material of the fiber impregnated with the resin and for vulcanizing the unvulcanized rubber to simultaneously obtain the fiber reinforced plastic and the vulcanized rubber material, and the obtained fiber reinforced plastic and vulcanized rubber material are integrated. In forming the fiber reinforced plastic from the prepreg, a part of the resin constituting the first precursor enters the unvulcanized rubber constituting the second precursor. In addition, in vulcanizing the unvulcanized rubber to form the rubber material, a part of the unvulcanized rubber constituting the second precursor enters the resin constituting the first precursor. By the aforementioned interaction between the first precursor and the second precursor, the first member 10 and the second member 20 are bonded to form the bonding part 30, and the first member 10 and the second member 20 are integrated. As a result, formed is the bonding part 30 where a surface portion of the fiber reinforced plastic constituting the first member 10 and a part of a matrix resin in a proximity of the surface portion enter a surface portion of the rubber material constituting the second member 20 and a proximity of the surface portion, and the surface portion of the rubber material constituting the second member 20 and a part of the proximity of the surface portion enter the surface portion of the fiber reinforced plastic constituting the first member 10 and the proximity of the surface portion. This wound composite material 1 forms the golf club shaft 100.

As the method for heat-treating the laminate of the first precursor and the second precursor, a heat-treating condition suitable for the first precursor can be appropriately selected.

(5) Step of withdrawing mandrel

The mandrel is withdrawn from the wound composite material 1 for removing the mandrel from the composite material 1 to manufacture the golf club shaft 100 of the present disclosure.

According to an aspect of the method for manufacturing a golf club shaft of the present disclosure, a step itself of applying an adhesive is not required, and therefore uniformly applying an adhesive is also not required for integrating the first member 10 containing the fiber reinforced plastic and the second member 20 containing the rubber material. Accordingly, complication of the manufacturing steps of the composite material 1 of the fiber reinforced plastic and the rubber material can be prevented, and manufacturing of the golf club shaft 100 can be simplified. In addition, in the method for manufacturing a golf club shaft of the present disclosure, the laminate of the first precursor and the second precursor is heat-treated for thermally curing the resin of the first precursor to obtain the first member 10 containing the fiber reinforced plastic, and for vulcanizing the unvulcanized rubber of the second precursor to obtain the second member 20 containing the rubber material, and the first member 10 and the second member 20 are strongly integrated, and therefore the composite material 1 of the fiber reinforced plastic and the rubber material, which can prevent the peeling between the first member 10 containing the fiber reinforced plastic and the second member 20 containing the rubber material, can be prepared. As a result, the golf club shaft 100 having the lightweight property and the high strength, and exhibiting the impact-absorption characteristics to suppress vibration at an impact of a golf ball can be manufactured.

In addition, according to an aspect of the method for manufacturing a golf club shaft of the present disclosure, the unvulcanized rubber is directly laminated onto the first precursor without interposing an adhesive member. Thus, adhesion unevenness due to the adhesive member can be prevented, and thereby the peeling between the first member 10 and the second member 20 can be prevented.

### Embodiment

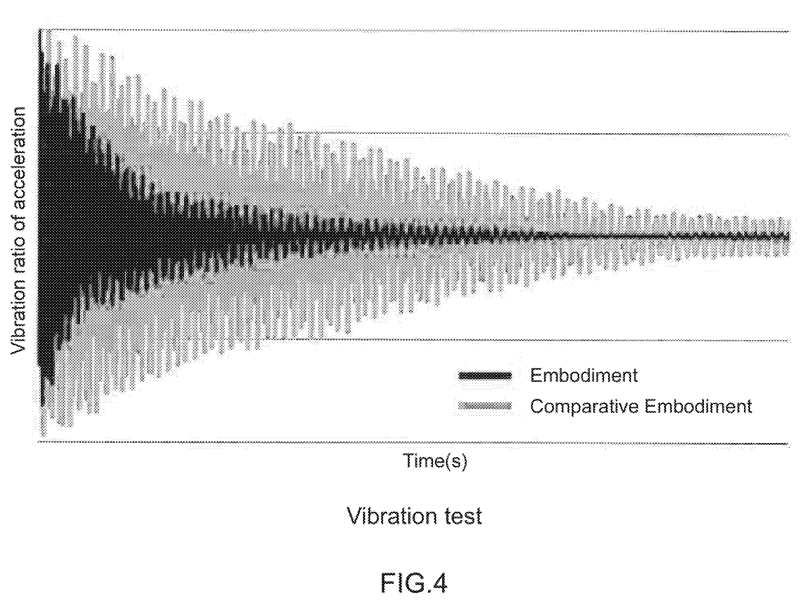

Next, Embodiment of the golf club shaft of the present disclosure will be described, but the golf club shaft of the present disclosure is not limited to the following Embodiment. FIG. 4 is a graph indicating results of a vibration test of a golf club shaft of Embodiment and a golf club shaft of Comparative Embodiment.

### Embodiment

A prepreg being a semi-cured material in which carbon fiber was impregnated with a thermosetting resin was used as a first precursor, an unvulcanized nitrile rubber was laminated as a second precursor onto the first precursor, and the first precursor was further laminated onto the second precursor to prepare a laminate in which a layer of the second precursor was interposed between layers of the first precursor (laminate of the first precursor and the second precursor). The obtained laminate was wound on an outer spherical surface of a mandrel, and heat-treated under conditions at 130°C for 90 minutes to obtain a wound composite material in which a first member containing a fiber reinforced plastic and a second member containing a rubber material were integrated. The mandrel was withdrawn from the wound composite material to manufacture a golf club shaft composed of the composite material.

### Comparative Embodiment

A golf club shaft made of steel was used instead of the golf club shaft composed of the composite material.

### Vibration test

The golf club shafts of Embodiment and Comparative Embodiment were subjected to a vibration test in which both the ends were free ends, a sensor was placed on the upper part, and the lower part was vibrated. The results of the vibration test were shown in FIG. 4.

As indicated in FIG. 4, in Embodiment, which used the golf club shaft composed of the composite material in which the first member containing the fiber reinforced plastic and the second member containing the rubber material were integrated, the golf club shaft exhibited impact-absorption characteristics, and it was found that the impact-absorption characteristics were exhibited at an impact of a golf ball for suppressing vibration to enable the golf club to exhibit clear hit feeling. Meanwhile, in Comparative Embodiment, which used the golf club shaft made of steel, the golf club shaft failed to sufficiently exhibit the impact-absorption characteristics, and it was found that the impact-absorption characteristics were failed to be exhibited at an impact of a golf ball, and the golf club failed to exhibit the clear hit feeling.

The golf club shaft and golf club of the present disclosure have high utility value in term of, for example, providing the golf club shaft and golf club having the lightweight property, the high strength, and the clear hit feeling to a golf player.

What is claimed is:

1. A golf club shaft, comprising a shaft body extending in a longitudinal direction, wherein
the shaft body is composed of a composite material which has: a first member containing a fiber reinforced plastic; and a second member containing a rubber material and formed to be in direct contact with the first member within at least a part of a region on the first member, and in which the first member and the second member are integrated.

2. The golf club shaft according to claim 1, wherein a part of the first member and the second member are in direct contact, and an adhesive member is not interposed between the first member and the second member.

3. The golf club shaft according to claim 1, wherein the first member and the second member are sheet-like, and the composite material has a laminate structure.

4. The golf club shaft according to claim 2, wherein the first member and the second member are sheet-like, and the composite material has a laminate structure.

5. The golf club shaft according to claim 1, wherein the rubber material is at least one selected from the group consisting of nitrile rubber, fluorine rubber, butyl rubber, ethylene-propylene-diene rubber, hydrogenated nitrile rubber, and silicone rubber.

6. The golf club shaft according to claim 2, wherein the rubber material is at least one selected from the group consisting of nitrile rubber, fluorine rubber, butyl rubber, ethylene-propylene-diene rubber, hydrogenated nitrile rubber, and silicone rubber.

7. The golf club shaft according to claim 1, wherein the rubber material is at least one selected from the group consisting of nitrile rubber, fluorine rubber, and butyl rubber.

8. The golf club shaft according to claim 2, wherein the rubber material is at least one selected from the group consisting of nitrile rubber, fluorine rubber, and butyl rubber.

9. The golf club shaft according to claim 1, wherein the fiber reinforced plastic is a carbon-fiber reinforced plastic.

10. The golf club shaft according to claim 2, wherein the fiber reinforced plastic is a carbon-fiber reinforced plastic.

11. The golf club shaft according to claim 1, wherein the first member is a multilayer structure having: a first one of the fiber reinforced plastic that forms a first layer in which a fiber orientation angle is a first direction; and a second one of the fiber reinforced plastic that forms a second layer in which a fiber orientation angle is a second direction different from the first direction.

12. The golf club shaft according to claim 2, wherein the first member is a multilayer structure having: a first one of the fiber reinforced plastic that forms a first layer in which a fiber orientation angle is a first direction; and a second one of the fiber reinforced plastic that forms a second layer in which a fiber orientation angle is a second direction different from the first direction.

13. The golf club shaft according to claim 1, wherein an outer surface of the composite material is of the first member.

14. The golf club shaft according to claim 2, wherein an outer surface of the composite material is of the first member.

15. The golf club shaft according to claim 1, wherein the shaft body has: a first region where a shaft outer diameter relatively gradually decreases; a second region where the shaft outer diameter relatively steeply decreases; and a third region where a relative amount of change in the shaft outer diameter is smallest, in this order from a base end side toward a distal end side in the longitudinal direction.

16. The golf club shaft according to claim 2, wherein the shaft body has: a first region where a shaft outer diameter relatively gradually decreases; a second region where the shaft outer diameter relatively steeply decreases; and a third region where a relative amount of change in the shaft outer diameter is smallest, in this order from a base end side toward a distal end side in the longitudinal direction.

17. A golf club, wherein a club head and a grip are attached to the golf club shaft according to claim 1.

18. A golf club, wherein a club head and a grip are attached to the golf club shaft according to claim 2.
